(19) United States
(12) Patent Application Publication
(10) Pub. No.: US 2012/0085239 A1
(43) Pub. Date: Apr. 12, 2012

(54) AERATION APPARATUS WITH ATOMIZING UNIT AND SEAWATER FLUE GAS DESULPHURIZATION APPARATUS INCLUDING THE SAME

(75) Inventors: Keisuke Sonoda, Tokyo (JP); Shozo Nagao, Tokyo (JP)

(73) Assignee: MITSUBISHI HEAVY INDUSTRIES, LTD., Tokyo (JP)

(21) Appl. No.: 13/017,599

(22) Filed: Jan. 31, 2011

Related U.S. Application Data
(60) Provisional application No. 61/405,797, filed on Oct. 22, 2010.

(30) Foreign Application Priority Data
Oct. 8, 2010 (JP) 2010-229119

(51) Int. Cl. C02F 1/74; B01D 47/00; B01F 3/04

(52) U.S. Cl. 96/235; 261/77; 210/758; 261/127

(57) ABSTRACT

An aeration apparatus is immersed in water to be treated and generates fine air bubbles in the water to be treated. The aeration apparatus includes: an air supply pipe for supplying air through discharge unit; aeration nozzles 123 including an introduction portion for introducing air 122 supplied from an opening 15a of a header 15 in communication with the air supply pipe, and a support body extending from the introduction portion and covered with a diffuser membrane having slits for discharging the air 122 to the outside; water introducing unit for introducing water into the header through the air supply pipe; and an atomizing unit 25 for atomizing the introduced water 141 with the aid of the air 122 supplied from the opening 15a of the header. Water mist 141a atomized by the atomizing unit 25 passes through the slit and is discharged to the outside together with the air 122.

### FIELD

The present invention relates to wastewater treatment in a flue gas desulphurization apparatus used in a power plant such as a coal, crude oil, or heavy oil combustion power plant. In particular, the invention relates to an aeration apparatus for aeration used for decarboxylation (air-exposure) of wastewater (used seawater) from a flue gas desulphurization apparatus for desulphurization using a seawater method. The invention also relates to a seawater flue gas desulphurization apparatus including the aeration apparatus and to a method for dissolving and removing precipitates in a slit of the aeration apparatus.

### BACKGROUND

In conventional power plants that use coal, crude oil, and the like as fuel, combustion flue gas (hereinafter referred to as “flue gas”) discharged from a boiler is emitted to the air after sulfur oxides (SOₓ) such as sulfur dioxide (SO₂) contained in the flue gas are removed. Known examples of the desulphurization method used in a flue gas desulphurization apparatus for the above desulphurization treatment include a limestone-gypsum method, spray dryer method, and seawater method.

In a flue gas desulphurization apparatus that uses the seawater method (hereinafter referred to as a “seawater flue gas desulphurization apparatus”), its desulphurization method uses seawater as an absorbent. In this method, seawater and flue gas from a boiler are supplied to the inside of a desulfurizer (absorber) having a vertical tubular shape such as a vertical substantially cylindrical shape, and the flue gas is brought into gas-liquid contact with the seawater used as the absorbent in a wet process to remove sulfur oxides. The seawater (used seawater) used as the absorbent for desulphurization in the desulfurizer flows through, for example, a long water passage having an open upper section (Seawater Oxidation Treatment System: SOTS) and is then discharged. In the long water passage, the seawater is decarbonated (exposed to air) by aeration that uses fine air bubbles ejected from an aeration apparatus disposed on the bottom surface of the water passage (Patent documents 1 to 3).

### CITATION LIST

### Patent Literature

Patent Literature 1: Japanese Patent Application Laid-open No. 2006-055779
Patent Literature 2: Japanese Patent Application Laid-open No. 2009-028570
Patent Literature 3: Japanese Patent Application Laid-open No. 2009-028572

### SUMMARY

### Technical Problem

Aeration nozzles used in the aeration apparatus each have a large number of small slits formed in a rubber-made diffuser membrane that covers a base. Such aeration nozzles are generally referred to as “diffuser nozzles.” These aeration nozzles can eject many fine air bubbles of substantially equal size from the slits with the aid of the pressure of the air supplied to the nozzles.

When aeration is continuously performed in seawater using the above aeration nozzles, precipitates such as calcium sulfate in the seawater are deposited on the wall surfaces of the slits of the diffuser membranes and around the openings of the slits, causing the gaps of the slits to be narrowed and the slits to be clogged. This results an increase in pressure loss of the diffuser membranes, and the discharge pressure of discharge unit, such as a blower or compressor, for supplying the air to the diffuser is thereby increased, so that disadvantageously the load on the blower or compressor increases.

The occurrence of the precipitates may be due to the following reason. Seawater present outside a diffuser membrane permeates inside the diffuser membrane through its slits and comes into continuous contact with air passing through the slits for a long time. Drying (concentration of the seawater) is thereby facilitated, and the precipitates are deposited.

In view of the above problem, it is an object of the present invention to provide an aeration apparatus that can remove precipitates and suppress the occurrence of precipitates in the slits of diffuser membranes, a seawater flue gas desulphurization apparatus including the aeration apparatus, and a method for dissolving and removing precipitates in the slits of the aeration apparatus.

### Solution to Problem

According to an aspect of the present invention, an aeration apparatus that is immersed in water to be treated and generates fine air bubbles in the water to be treated, the aeration apparatus includes: an air supply pipe for supplying air through discharge unit; an aeration nozzle including an introduction portion for introducing air supplied from an opening of a header that is in communication with the air supply pipe, and a support body extending from the introduction portion and covered with a diffuser membrane having a slit for discharging the air to the outside; water introducing unit for introducing water into the header through the air supply pipe; and an atomizing unit for atomizing the introduced water with the aid of the air supplied from the opening of the header. Water mist atomized by the atomizing unit passes through the slit and is discharged to the outside together with air.

Advantageously, the aeration apparatus, further includes control unit for performing control to introduce water into the header through the air supply pipe when pressure loss of the aeration nozzle is a predetermined value or more.

Advantageously, in the aeration apparatus, the shape of the opening is any of a circle and a rectangle.

Advantageously, in the aeration apparatus, the atomizing unit includes a vent pipe disposed in the opening of the header; and a water introduction pipe, a bottom end portion of which is immersed below the surface of the water in the header and an upper end portion of which faces the interior of the vent pipe.

Advantageously, in the aeration apparatus, the water is one of fresh water and seawater.

Advantageously, in the aeration apparatus, a filter and a cooling unit are provided in the air supply pipe.

According to another aspect of the present invention, a seawater flue gas desulphurization apparatus includes: a desulfurizer that uses seawater as an absorbent; a water passage for allowing used seawater discharged from the desulfurizer to flow therethrough and be discharged; and the aeration apparatus above described that is disposed in the water passage and generates fine air bubbles in the used seawater to decarbonate the used seawater.

According to still another aspect of the present invention, a method for dissolving and removing a precipitate in a slit in an aeration apparatus includes: using an aeration apparatus that is immersed in water to be treated and used to generate fine air bubbles in the water to be treated from a slit of a diffuser membrane of an aeration nozzle; introducing water into a vent pipe and atomizing the water when air is supplied to the aeration nozzle; and supplying the water containing atomized water mist to the slit of the diffuser membrane for dissolving and removing a precipitate.

### Advantageous Effects of Invention

According to the present invention, even when precipitates are generated in the slits of the diffuser membranes of the aeration apparatus, the precipitates can be dissolved and removed. Therefore, it is possible to reduce the load on discharge unit, such as a blower or compressor, for supplying air to the aeration apparatus. Further, atomizing unit supplies air entraining water mist to the slits of the diffuser membranes. Therefore, drying and concentration of seawater in the slits of the diffuser membranes can be prevented, and deposition of precipitates such as calcium sulfate can thereby be avoided.

### BRIEF DESCRIPTION OF DRAWINGS

FIG. 1 is a schematic diagram of a seawater flue gas desulphurization apparatus according to an embodiment.

FIG. 2-1 is a plan view of aeration nozzles.

FIG. 2-2 is a front view of the aeration nozzles.

FIG. 3 is a schematic diagram of the inner structure of an aeration nozzle.

FIG. 4 is a schematic diagram of an aeration apparatus according to an embodiment.

FIG. 5-1 is a diagram illustrating an example of another atomizing unit.

FIG. 5-2 is a diagram illustrating an example of another atomizing unit.

FIG. 6 is a set of graphs showing a relationship between pressure loss and time (upper graph) and a relationship between water flow rate and time (lower graph).

FIG. 7-1 is a diagram illustrating the states of the outflow of air, the inflow of seawater, and concentrated seawater in a slit of a diffuser membrane.

FIG. 7-2 is a diagram illustrating the states of the outflow of air, the inflow of seawater, concentrated seawater, and a precipitate in the slit of the diffuser membrane.

FIG. 8 is a flowchart of an operation.

### DESCRIPTION OF EMBODIMENTS

Hereinafter, the present invention will be described in detail with reference to the drawings. However, the present invention is not limited to embodiments described below. The components in the following embodiments include those readily apparent to persons skilled in the art and those substantially similar thereto.

### Embodiments

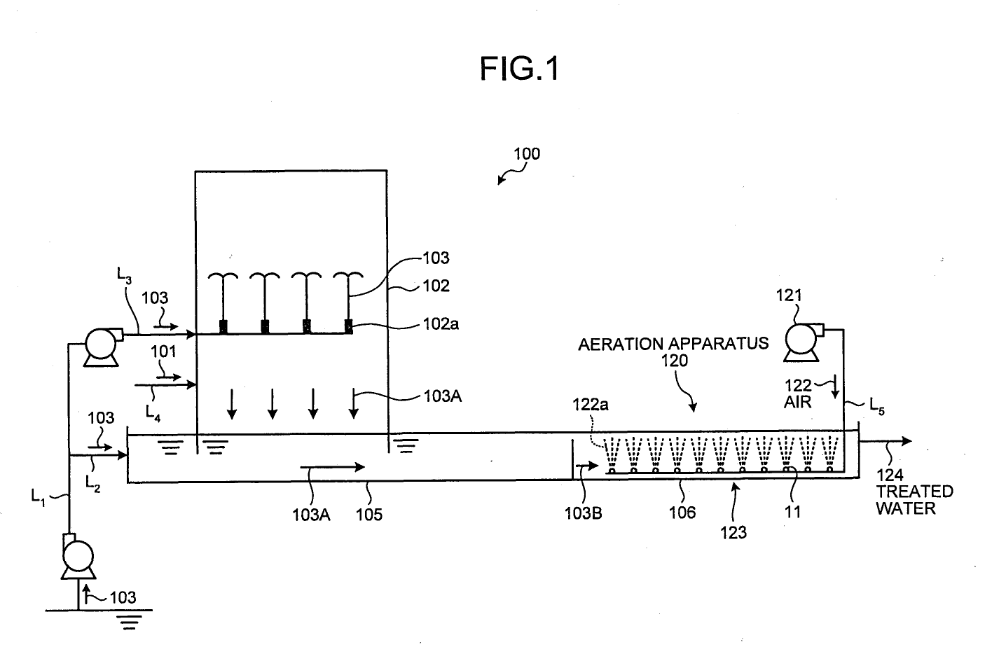

An aeration apparatus and a seawater flue gas desulphurization apparatus according to embodiments of the present invention will be described with reference to the drawings. FIG. 1 is a schematic diagram of the seawater flue gas desulphurization apparatus according to one embodiment.

As shown in FIG. 1, a seawater flue gas desulphurization apparatus 100 includes: a flue gas desulphurization absorber 102 in which flue gas 101 and seawater 103 comes in gas-liquid contact to desulphurize SO₂ into sulfurous acid (H₂SO₃); a dilution-mixing basin 105 disposed below the flue gas desulphurization absorber 102 to dilute and mix used seawater 103A containing sulfur compounds with dilution seawater 103; and an oxidation basin 106 disposed on the downstream side of the dilution-mixing basin 105 to subject diluted used seawater 103B to water quality recovery treatment.

In the seawater flue gas desulphurization apparatus 100, the seawater 103 is supplied through a seawater supply line L₁, and part of the seawater 103 is used for absorption, i.e., is brought into gas-liquid contact with the flue gas 101 in the flue gas desulphurization absorber 102 to absorb SO₂ contained in the flue gas 101 into the seawater 103. The used seawater 103A that has absorbed the sulfur components in the flue gas desulphurization absorber 102 is mixed with the dilution seawater 103 supplied to the dilution-mixing basin 105 disposed below the flue gas desulphurization absorber 102. The diluted used seawater 103B diluted and mixed with the dilution seawater 103 is supplied to the oxidation basin 106 disposed on the downstream side of the dilution-mixing basin 105. Air 122 supplied from an oxidation air blower 121 is supplied to the oxidation basin 106 from aeration nozzles 123 to recover the quality of the seawater, and the resultant water is discharged to the sea as treated water 124.

In FIG. 1, reference numeral 102a represents spray nozzles for injecting seawater 103 upward as liquid columns; 120 represents an aeration apparatus; 122a represents air bubbles; L₁ represents a seawater supply line; L₂ represents a dilution seawater supply line; L₃ represents a desulphurization seawater supply line; L₄ represents a flue gas supply line; and L₅ represents an air supply line.

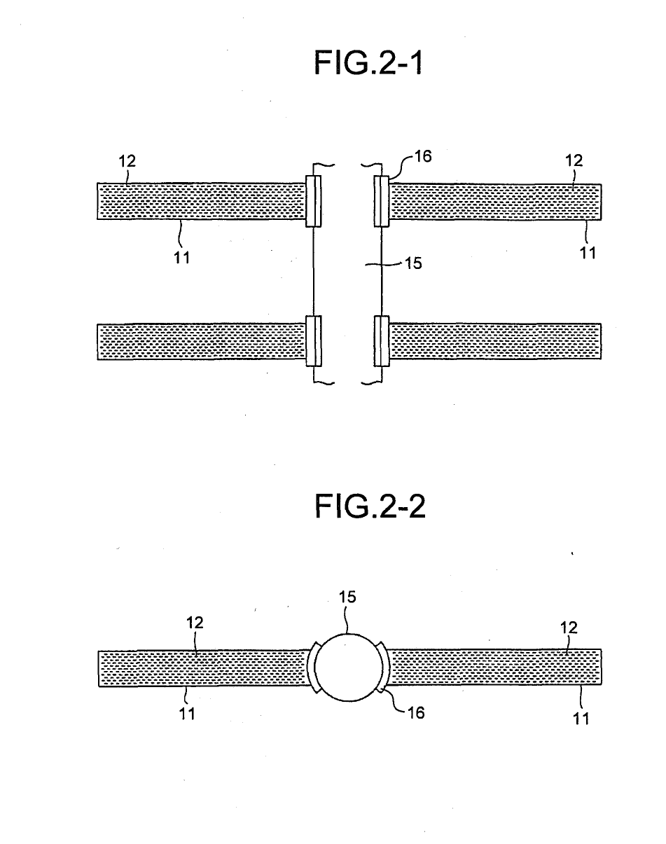

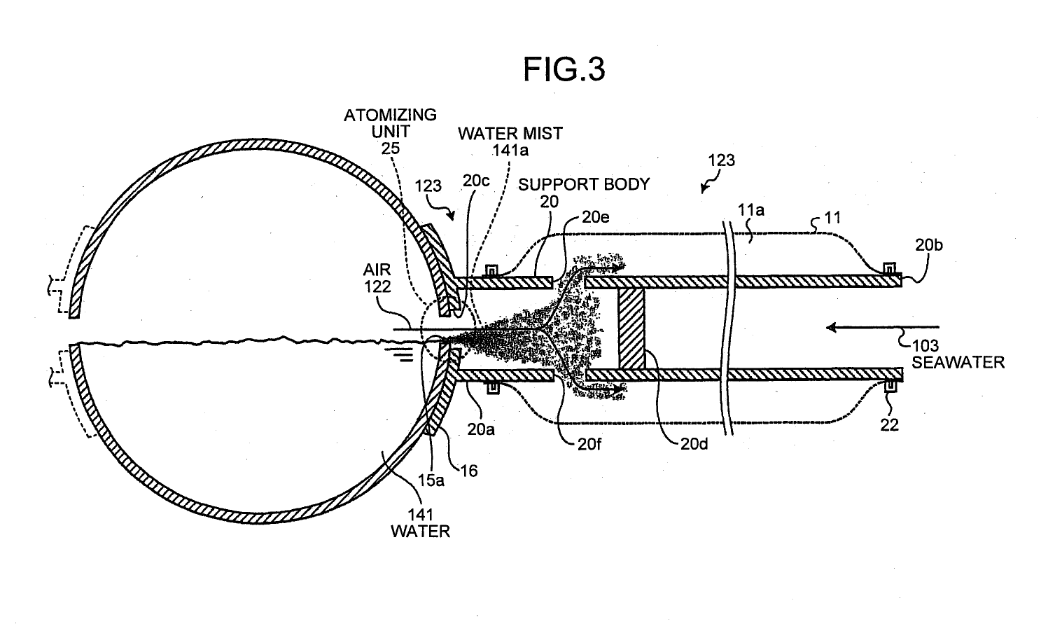

The structure of the aeration nozzles 123 is described with reference to FIGS. 2A, 2B, and 3 when a diffuser membrane is made of rubber.

FIG. 2A is a plan view of the aeration nozzles; FIG. 2B is a front view of the aeration nozzles; and FIG. 3 is a schematic diagram of the inner structure of an aeration nozzle.

As shown in FIGS. 2A and 2B, each aeration nozzle 123 has a large number of small slits 12 formed in a rubber-made diffuser membrane 11 that covers the circumference of a base and is generally referred to as a “diffuser nozzle.” In such an aeration nozzle 123, when the diffuser membrane 11 is expanded by the pressure of the air 122 supplied from the air supply line L₅, the slits 12 open to allow a large number of fine air bubbles of substantially equal size to be ejected.

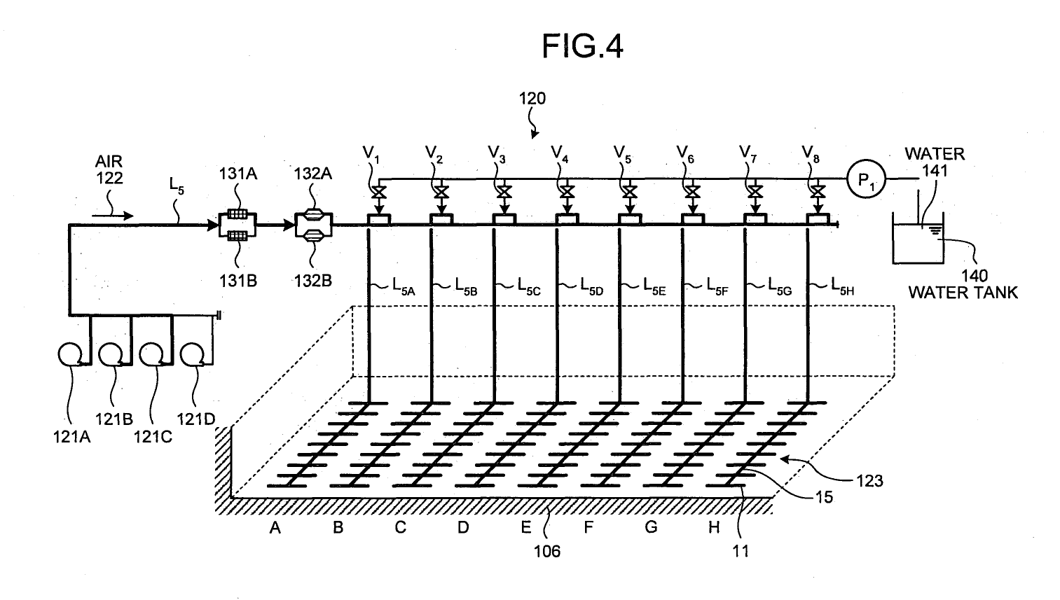

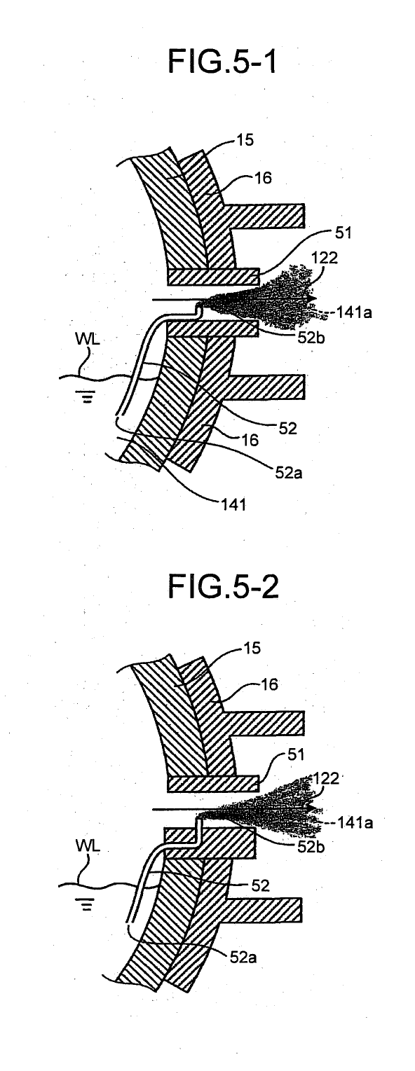

As shown in FIGS. 2A and 2B, the aeration nozzles 123 are attached through flanges 16 to headers 15 provided in a plurality of (eight in the present embodiment) branch pipes (not shown) branched from the air supply line L₅. In consideration of corrosion resistance, resin-made pipes, for example, are used as the headers 15 disposed in the diluted used seawater 103B. As shown in FIG. 4 describe below, the headers 15 are used to introduce the air 122 into the aeration nozzles 123 through the branch air supply lines L_{5A} to L_{5H} that are branched from the air supply line L₅ disposed in the diluted used seawater 103B.

For example, as shown in FIG. 3, each aeration nozzle 123 is formed as follows. A substantially cylindrical support body 20 that is made of a resin in consideration of corrosion resistance to the used seawater 103B is used, and a rubber-made diffuser membrane 11 having a large number of slits 12 formed therein is fitted on the support body 20 so as to cover its outer circumference. Then the left and right ends of the diffuser membrane 11 are fastened with fastening members 22 such as wires or bands.

The slits 12 described above are closed in a normal state in which no pressure is applied thereto. In the seawater flue gas desulphurization apparatus 100, when the air 122 is continuously supplied, the slits 12 are constantly in an open state.

A first end 20a of the support body 20 is attached to a header 15 and allows the introduction of the air 122, and the support body 20 has an opening at its second end 20b that allows the introduction of the seawater 103.

In the support body 20, the side close to the first end (an air introduction portion) 20a is in communication with the inside of the header 15 through an air inlet port 20c that passes through the header 15 and the flange 16. The inside of the support body 20 is partitioned by a partition plate 20d disposed at some axial position in the support body 20, and the flow of air is blocked by the partition plate 20d. Air outlet holes 20e and 20f are formed in the side surface of the support body 20 and disposed on the header 15 side of the partition plate 20d. The air outlet holes 20e and 20f allow the air 122 to flow between the inner circumferential surface of the diffuser membrane 11 and the outer circumferential surface of the support body, i.e., into a pressurization space 11a for pressurizing and expanding the diffuser membrane 11. Therefore, the air 122 flowing from the header 15 into the aeration nozzle 123 flows through the air inlet port 20c into the support body 20 and then flows through the air outlet holes 20e and 20f formed in the side surface into the pressurization space 11a, as shown by arrows in FIG. 3.

The fastening members 22 fasten the diffuser membrane 11 to the support body 20 and prevent the air flowing through the air outlet holes 20e and 20f from leaking from the opposite ends.

In the aeration nozzle 123 configured as above, the air 122 flowing from the header 15 through the air inlet port 20c flows through the air outlet holes 20e and 20f into the pressurization space 11a. Since the slits 12 are closed in the initial state, the air 122 is accumulated in the pressurization space 11a to increase the inner pressure. The increase in the inner pressure of the pressurization space 11a causes the diffuser membrane 11 to expand, and the slits 12 formed in the diffuser membrane 11 are thereby opened, so that fine bubbles of the air 122 are injected into the diluted used seawater 1038. Such fine air bubbles are generated in all the aeration nozzles 123 to which air is supplied through the branch air supply lines L_{5A} to L_{5H} (which will be described later) and the headers 15.

Aeration apparatuses according to an embodiment will next be described. The present invention provides means for removing and suppressing deposition of precipitates such as calcium sulfate in the slits 12 by introducing atomized water together with air into the slits 12 of the diffuser membranes 11.

The present invention will next be described specifically.

FIG. 4 is a schematic diagram of the aeration apparatus according to the present embodiment.

As shown in FIG. 4, an aeration apparatus 120 according to the present embodiment is immersed in diluted used seawater (not shown), which is water to be treated, and generates fine air bubbles in the diluted used seawater 103B. This aeration apparatus includes: an air supply line L₅ for supplying the air 122 from blowers 121A to 121D serving as discharge unit; a water tank 140 and a supply pump P₁, which are moisture supplying unit for supplying water 141 to the air supply line L₅; and aeration nozzles 123 each including a diffuser membrane 11 having slits 12 for supplying air containing moisture.

Two cooling units 131A and 131B and two filters 132A and 132B are provided in the air supply line L₅. The air compressed by the blowers 121A to 121D is thereby cooled and then filtrated.

Normally, three of the four blowers are used for operation, and one of them is a reserve blower. Since the aeration apparatus must be continuously operated, only one of the two cooling units 131A and 131B and only one of the two filters 132A and 132B are normally used, and the others are used for maintenance.

In the present embodiment, fresh water is used to supply moisture. However, instead of the fresh water, seawater (such as seawater 103 from the dilution seawater supply line L₂, used seawater 103A in the dilution-mixing basin 105, or diluted used seawater 103B in the oxidation basin 106) may be used.

In the present embodiment, the water (fresh water or seawater) 141 is supplied from the water tank 140. The supplied water is accumulated in the bottom section below an opening 15a in the header 15, and ejected toward the aeration nozzle 123 from the opening 15a. The water 141 passing through the opening 15a can be atomized when the air 122 supplied to the aeration nozzle 123 passes through the opening 15a.

More specifically, the air 122 is supplied to the orifices of the opening 15a and the air inlet port 20c in order to generate water mist 141a.

An atomizing unit 25 shown in FIG. 3 is made up of the water 141 introduced into the header 15 and the orifices of the opening 15a and the air inlet port 20c allow the atomizing unit 25 to function.

FIGS. 2A and 2B are diagrams illustrating another examples of the atomizing unit.

An atomizing unit shown in FIG. 2A includes a vent pipe 51 disposed in the opening 15a of the header 15; and a water introduction pipe 52, a bottom end portion 52a of which is immersed below the surface of the water in the header 15 and an upper end portion 52b of which faces the interior of the vent pipe 51.

Since the flow velocity of the air 122 that passes through the opening of the upper end portion 52b is fast, the water is ruffled, and the ruffled water 141 is atomized to generate the water mist 141a.

In the example shown in FIG. 2B, a part of the water introduction pipe 52 is buried in a hollow vent pipe 51, and an opening of the upper end portion 52b faces the hollow vent pipe 51.

The shape of the opening 15a may be any of a circle, a rectangle, and a rhomboid.

As described above, since the water 141 is atomized and entrained into the air 122 to be introduced, humid air is supplied to the aeration nozzle 123. This allows for the following effects 1) and 2).

1) Even when precipitates are generated in the slits 12 of the diffuser membranes 11 of the aeration apparatus 120, the water mist 141a generated by the atomizing unit 25 allows the precipitates to be dissolved and removed. Therefore, the load on the discharge unit, such as a blower or compressor, for supplying the air 122 to the aeration apparatus 120 can be reduced.
2) The atomizing unit 25 supplies the air 122 entraining the water mist 141a to the slits 12 of the diffuser membranes 11. This prevents drying and concentration of seawater in the slits 12 and thereby prevents the deposition of precipitates such as calcium sulfate.

In the case of 2), generation of the water mist 141a prevents drying (concentration) of seawater that enters the slits 12 of the diffuser membranes 11 and thereby prevents deposition of salts, such as calcium sulfate, in the seawater. When concentrated seawater is formed in the slits 12, the atomized water mist 141a contributes to relaxation of the concentration of the seawater (a reduction in salt concentration).

Since the water mist 141a is vaporized, the relative humidity of the supplied air increases, so that the drying (concentration) of the seawater that enters the slits 12 can further be prevented in addition to the above.

The water (freshwater or seawater) 141 is introduced near the opening 15a in the header 15 and atomized when the air 122 to be supplied to the aeration nozzle 123 passes through the opening 15a and the air inlet port 20c. Accordingly, the air 122 entraining the atomized water mist 141a is introduced into the slit 12. Therefore, the calcium sulfate and the like adhered to the slit 12 of the diffuser membrane 11 is dissolved, and pressure loss of the diffuser membrane 11 is thereby reduced. It is also possible to prevent the occurrence of deposition.

When the water level WL of the introduced water 141 in the header 15 is lower than the opening 15a, the water cannot be atomized, so that the water mist 141a cannot be generated at the orifice. In this case, it is possible to generate the water mist 141a by applying the cases shown in FIGS. 2A and 2B.

When the water level WL is higher than the opening 15a, the water 141 alone is introduced into the aeration nozzle 123 and contributes to dissolution of precipitates in the slit 12. When the water level WL of the water 141 becomes appropriate, the water mist 141 can be generated by atomization with the aid of the air 122.

The water 141 is introduced from the water tank 140 through the pump P₁. Specifically, the water 141 is introduced into an air introduction pipe by increasing the water pressure than the inner pressure of the air introduction pipe. When the water pressure is low, a booster pump is used.

### [Measures Against Generation of Adhered Matters]

At the initial stage of the operation of the aeration apparatus 120, a control unit introduces the air 122 into the air supply line L₅ and performs only aeration. At this time, the water 141 is not introduced into the air supply line L₅.

When adhered matters are generated in the slits 12, the pressure loss of the aeration nozzles 123 increases to a defined value or more. When such an increase in the pressure loss occurs, the water 141 is introduced into the branch air supply lines L_{5A} to L_{5H}, which are branched from the air supply line L₅, from the water tank 140. When the introduced water 141 reaches an inlet portion of each of the aeration nozzles 123, the water mist 141a can be generated by the atomization action of the air 122.

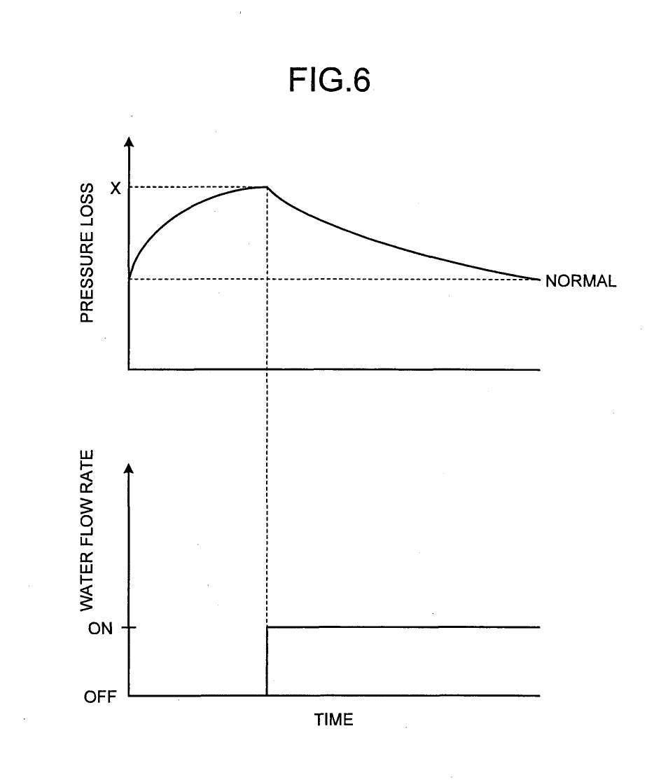

A relationship between pressure loss and time and a relationship between water flow rate and time are illustrated in FIG. 6.

FIG. 6 is a set of graphs showing the relationship between pressure loss and time (upper graph) and the relationship between water flow rate and time (lower graph).

As shown in FIG. 6, when the pressure loss is increased to a predetermined value X, the water 141 is introduced (ON). The introduction of the water 141 is continued until the pressure loss reaches the allowable range of a normal value.

If the introduction of the water 141 is stopped when the pressure loss reaches the normal value, the pressure loss starts increasing again as soon as the effect of the water is lost.

In contrast, when the pressure loss reaches the normal value, if the amount of the water 141 to be introduced is adjusted so that the relative humidity of the air that flows into the slit 12 remains about 100% and the water is continuously introduced, it is possible to prevent the pressure loss from increasing from the normal value.

When a plurality of air supply pipes is provided, taking the above measure for each block allows for efficient operation.

The salt concentration in seawater is generally about 3.4%, and 3.4% of salts are dissolved in 96.6% of water. The salts include 77.9% of sodium chloride, 9.6% of magnesium chloride, 6.1% of magnesium sulfate, 4.0% of calcium sulfate, 2.1% of potassium chloride, and 0.2% of other salts.

Of these salts, calcium sulfate is deposited first as seawater is concentrated (dried), and the deposition threshold value of the salt concentration in seawater is about 14%.

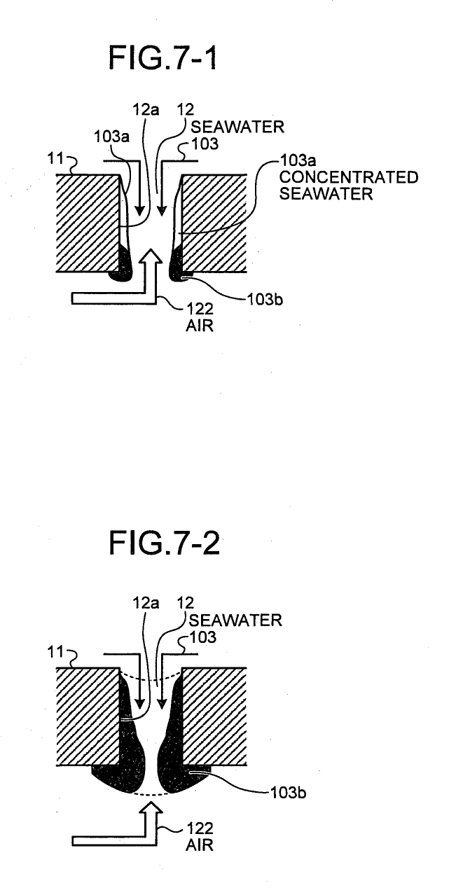

FIGS. 7A and 7B are diagrams illustrating the outflow of air (to which moisture has been supplied), the inflow of the seawater 103, and generation of adhered matters in a slit 12 of a diffuser membrane 11.

In the present invention, the slits 12 are cuts formed in the diffuser membranes 11, and the gap of each slit 12 serves as a discharge passage of the air 122.

The seawater 103 is in contact with slit wall surfaces 12a that form the passage. The introduction of the air 122 causes the seawater 103 to be dried and concentrated to form concentrated seawater 103a. Then a precipitate 103b is deposited on the slit wall surfaces and clogs the passage in the slit.

FIGS. 7A and 7B show the growth states of the precipitate in the slit 12 of the diffuser membrane 11 as the drying and concentration of the seawater due to the air 122 proceed.

In the state shown in FIG. 7A, the precipitate 103b is generated in portions of the concentrated seawater 103a in which the salt concentration in the seawater locally exceeds 14%. In this state, the amount of the precipitate 103b is very small. Therefore, although the pressure loss when the air 122 passes through the slit 12 increases slightly, the air 122 can pass through the slit 12.

However, in the state shown in FIG. 7B, since the concentration of the concentrated seawater 103a has proceeded further, a clogged (plugged) state due to the precipitate 103b is formed, and the pressure loss is high. Therefore, the pressure loss of the aeration nozzle 123 increases.

When a clogged (plugged) state due to the precipitate 103b is formed and the pressure loss increases, the atomizing unit 25 generates the water mist 141a and causes the air 122, which is to be supplied to the aeration nozzle 123, to entrain the water mist 141a. Therefore, the adhered matters in the slit 12 can be removed. By further supplying the water mist 141a, concentration (an increase in the salt concentration) of the seawater can be prevented, and the deposition of calcium sulfate and the like can thereby prevented.

This can prevent the narrowing of the gaps of the slits 12 due to the deposition of calcium sulfate and the like and the clogging of the slits 12, and the pressure loss of the diffuser membranes 11 can thereby be prevented.

The introduction of the water into the header is performed by using a control unit described below. However, the water may be introduced by manually operating an air valve and a water valve.

The control unit is made up of a microcomputer or the like. The control unit is provided with a storage unit (not shown) made up of a RAM or ROM for storing programs and data. When an increase in the pressure loss of the aeration nozzle 123 to a predetermined value or more is confirmed, the data stored in the storage unit is used for detecting generation of a large amount of adhered matters in the slit 12 and confirming a block in which the pressure loss of the aeration nozzle 123 occurs from among blocks (eight blocks in the present embodiment (first to eighth blocks A to H shown in FIG. 4)).

The control unit is connected to the valves V₁ to V₈ of the branch air supply lines L_{5A} to L_{5H} for supplying the water 141 from the water tank 140. When the pressure loss occurs, the control unit keeps supplying the air 122 and issues a command to open a valve to only a block in which the pressure loss has occurred, so that the water 141 is supplied from the water tank 140 and introduced into the branch air supply lines L_{5A} to L_{5H}.

For example, when an increase in the pressure loss in the first block A is confirmed, the water 141 is introduced into the branch air supply line L_{5A}. When the water is introduced into the opening 15a of the header 15, the atomizing unit 25 generates the water mist 141a, so that the air 122 entraining the water mist 141a is introduced into the aeration nozzle 123. Therefore, precipitates such as calcium sulfate deposited in the slit 12 are dissolved.

After confirming a decrease in the pressure loss of the aeration nozzle 123 due to the dissolution, the control unit issues a command to stop the introduction of the water 141 and resumes a normal aeration operation for supplying only the air 122.

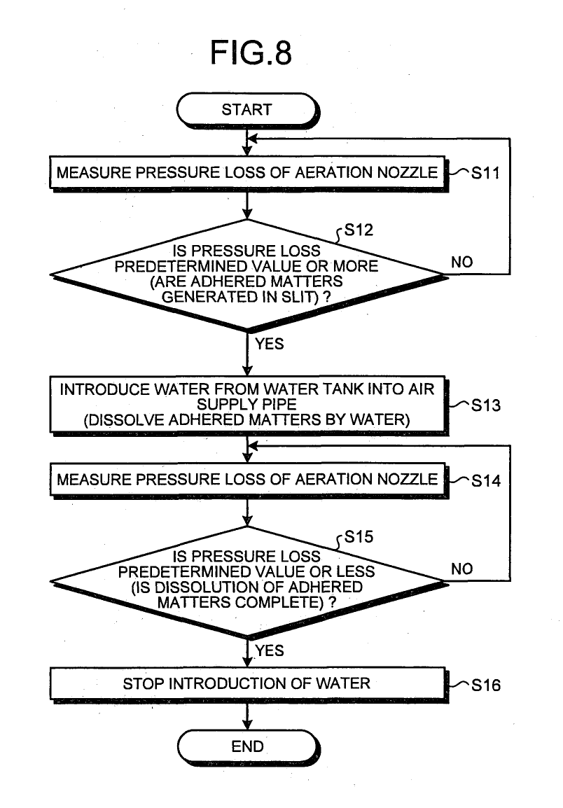

Control performed by the control unit when the pressure loss of the aeration nozzle 123 increases will next be described. FIG. 8 is a flowchart of an operation.

The control unit measures pressure (inner pressure of a diffuser pipe and water pressure) using a manometer (not shown) and measures pressure loss of the aeration nozzle 123 (Step S11). When the measured pressure loss is smaller than a predetermined value (adhered matters are not generated in the slit 12) (Step S12: NO), the control unit continues measurement of the pressure loss.

When the measured pressure loss is the predetermined value or more (adhered matters are generated in the slit 12) (Step S12: Yes), the control unit performs control to introduce the water 141 from the water tank 140 into the air supply pipe so that the water level reaches a position near the opening 15a in the header 15. This allows generation of the water mist 141a, and the adhered matters are dissolved (Step S13).

While the water 141 is being introduced and the water mist 141a is being generated, the control unit measures pressure (inner pressure and water pressure) (Step S14).

When the pressure loss reaches the predetermined value or less based on the measurement at Step S14 (Step S15: YES), the control unit stops the introduction of the water (Step S16), and performs normal aeration.

When the pressure loss is the predetermined value or more based on the measurement at Step S14 (Step S15: NO), the control unit continues the introduction of the water 141 and monitoring of the pressure loss at Step S14.

When the pressure loss reaches the predetermined value or less based on the measurement at Step S14 (Step S15: YES), the control unit stops the introduction of the water (Step S16).

The control unit continues the monitoring of an increase in the pressure loss of the aeration nozzle. When the pressure loss increases again, the control unit performs the same operation.

In the present embodiment, when plugging occurs due to deposition of seawater components and contamination components such as sludge on diffuser slits (membrane slits), the plugging can be quickly relieved in the aeration apparatuses for aeration of seawater. Therefore, the aeration apparatuses can be stably operated for a long time.

### [Measures for Suppressing Generation of Adhered Matters]

As described above, by causing the atomizing unit 25 to supply the air 122 entraining the water mist 141a to the slits 12 of the diffuser membranes 11, drying and concentration of seawater in the slits 12 of the diffuser membranes 11 can be prevented, and the deposition of precipitates such as calcium sulfate can thereby be avoided.

In this case, the control unit introduces the water 141 from the water tank 140 into the air supply pipe and generates the water mist 141a at the opening 15a in the header 15 from the initial stage of the operation of the aeration apparatus.

The generation of the water mist 141a prevents drying (concentration) of the seawater that enters the slits 12 of the diffuser membranes 11, and thereby prevents the deposition of salts, such as calcium sulfate, in the seawater. When the concentrated seawater 103a is formed in the slits 12, the atomized water mist 141a contributes to relaxation of the concentration of the seawater (a reduction in salt concentration).

This prevents generation of adhered matters in the slits 12. Therefore, an increase in pressure loss can be prevented, and the aeration apparatuses can be stably operated for a long time.

In the description in the present embodiment, seawater is exemplified as water to be treated, but the invention is not limited thereto. For example, in an aeration apparatus for aerating polluted water in polluted water treatment (such as sewage treatment), plugging caused by deposition of contamination components such as sludge on diffuser slits (membrane slits) can be prevented, and the aeration apparatus can be stably operated for a long time.

In the description of the present embodiment, tube-type aeration nozzles are used in the aeration apparatuses, but the present invention is not limited thereto. For example, the invention is applicable to disk-type and flat-type aeration apparatuses having diffuser membranes and to diffusers including ceramic or metal diffuser membranes having slits that are open at all times.

### INDUSTRIAL APPLICABILITY

As described above, in the aeration apparatus according to the present invention, precipitates generated in the slits of the diffuser membranes of the aeration apparatus can be removed and the occurrence of the precipitates can be suppressed. For example, when applied to a seawater flue gas desulphurization apparatus, the aeration apparatus can be continuously operated in a stable manner for a long time.

### REFERENCE SIGNS LIST

11 diffuser membrane
12 slit
100 seawater flue gas desulphurization apparatus
102 flue gas desulphurization absorber
103 seawater
103a concentrated seawater
103b precipitate
103A used seawater
103B diluted used seawater
105 dilution-mixing basin
106 oxidation basin
120 aeration apparatus
122 air
123 aeration nozzle
140 water tank
141 water
141a water mist

1. An aeration apparatus that is immersed in water to be treated and generates fine air bubbles in the water to be treated, the aeration apparatus comprising:
an air supply pipe for supplying air through discharge unit;
an aeration nozzle including an introduction portion for introducing air supplied from an opening of a header that is in communication with the air supply pipe, and a support body extending from the introduction portion and covered with a diffuser membrane having a slit for discharging the air to the outside;
water introducing unit for introducing water into the header through the air supply pipe; and
an atomizing unit for atomizing the introduced water with the aid of the air supplied from the opening of the header, wherein
water mist atomized by the atomizing unit passes through the slit and is discharged to the outside together with air.

2. The aeration apparatus according to claim 1, further comprising:
control unit for performing control to introduce water into the header through the air supply pipe when pressure loss of the aeration nozzle is a predetermined value or more.

3. The aeration apparatus according to claim 1, wherein
the shape of the opening is any of a circle and a rectangle.

4. The aeration apparatus according to claim 1, wherein
the atomizing unit includes
a vent pipe disposed in the opening of the header; and
a water introduction pipe, a bottom end portion of which is immersed below the surface of the water in the header and an upper end portion of which faces the interior of the vent pipe.

5. The aeration apparatus according to claim 1, wherein
the water is one of fresh water and seawater.

6. The aeration apparatus according to claim 1, wherein
a filter and a cooling unit are provided in the air supply pipe.

7. A seawater flue gas desulphurization apparatus, comprising:
a desulfurizer that uses seawater as an absorbent;
a water passage for allowing used seawater discharged from the desulfurizer to flow therethrough and be discharged; and
the aeration apparatus according to claim 1 that is disposed in the water passage, the aeration apparatus generating fine air bubbles in the used seawater to decarbonate the used seawater.

8. A method for dissolving and removing a precipitate in a slit in an aeration apparatus, comprising:
using an aeration apparatus that is immersed in water to be treated and used to generate fine air bubbles in the water to be treated from a slit of a diffuser membrane of an aeration nozzle;
introducing water into a vent pipe and atomizing the water when air is supplied to the aeration nozzle; and
supplying the water containing atomized water mist to the slit of the diffuser membrane for dissolving and removing a precipitate.
